(19) United States
(12) Patent Application Publication
(10) Pub. No.: US 2005/0224123 A1
(43) Pub. Date: Oct. 13, 2005

(54) Integral centraliser

(76) Inventors: Richard Ronald Baynham, Marina Di Ravenna (IT); David Levie, Buende (DE); Anatoly Baryshnikov, Milanese (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/524,371

(22) PCT Filed: Aug. 12, 2002
(86) PCT No.: PCT/IT02/00536

§ 371 Date: Feb. 10, 2005

(51) Int. Cl. F16L 3/00

(52) U.S. Cl. 138/106; 138/112; 138/146; 138/DIG. 11

(57) ABSTRACT

A method of providing at least one projection on a tubular body. The tubular body may be one required by the oil and gas industry for use in recovery of and transporting of crude oil or gas, namely oil-country-tubular goods. The projection has a predetermined form such as a blade, ribbing, or the like stand-off projection. The method provides materials capable of being molded, applying a mold to a tubular body, and molding the material using the mold onto the tubular body.

This invention relates to tubular products of the type required by the oil and gas industry for use in recovery of and transporting of crude oil or gas, namely oil-country-tubular goods(OCTG), particularly a tubular product adapted to be inserted downhole in a centralised position.

The use of centralising means for aligning a tubular product (hereinafter “tubular”) within a well bore is well known in the field. A typical centraliser (or centralizer) takes the form of an open-ended substantially cylindrical hollow body to be attached as a close-fitting sleeve or collar around a tubular. The body is provided with radially projecting parts such as ribbing or spaced apart blades so that fluid pathways are defined between the projecting parts permitting fluids to pass around the centraliser when it is located in the bore. The projecting parts provide lands for engagement of downhole surfaces to provide a means of making the tubular stand-off to its intended centralised position. The design of the projecting parts varies from axially aligned “vertical” blades through off-set-straight to helical or “spiral” patterns, and continuous or interrupted (slotted) blade designs often with bevelled ends. The lands may be so designed that in situ downhole they are used to divert the tubular to follow a deviation in bore path, and so design specification for one centraliser may also differ in this respect from that of another centraliser.

Whilst numerous types of centralisers are known, the common purpose for a typical centraliser is that it is intended to be located on a tubular body such as casing, pipe, or similar conduit, or a tool to be installed in a bore hole, and is retained in a desired axial position on the tubular by fasteners, stop collars, welding, cementing, or by use of adhesive or simply frictional engagement over the tubular. Certain types of centralisers are of the “rotating” type which are fixed onto a tubular body to turn with the tubular, and others are of the “non-rotating” type which are axially retained on the tubular, but are equipped with roller devices so that when the lands thereof engage within the bore, the tubular will rotate within the centraliser.

The known centralisers are in the main made from metal, such as aluminium, steel, and zinc, typically nowadays by casting methods but possibly by extrusion, and recently special alloys have become popular for special purposes, e.g. zinc alloys and bronze alloys. There have been also proposals for centralisers made of, or including plastics, e.g. durable plastic resins such as NYLON, and TEFLON. Use of special materials for the surfaces of the lands has been proposed, including zirconia, titania, alumina and metal carbides.

Reference may be made to the patent literature to obtain more details of the centralisers previously proposed for use in this industry. British patent publications in this field include: GB-A-2 016 063, GB-A-2 148 984, GB-A 2 148 985, GB-A-2 155 519, GB-A-2 171 436, GB-A-2 197 008, GB-A-2 201 176, GB-A-2 210 084, GB-A-2 210 085, GB-A-2 230 808, GB-A-2 241 009, GB-A-2 242 457, -GB-A-2 249 333, GB-A-2 252 118, GB-A-2 253 428, GB-A-2 272 233, GB-A-2 277 336, GB-A-2 282 615, GB-A-2 285 649, GB-A-2 290 331, GB-A-2 304 753, GB-A-2 316 422, GB-A-2 331 534, GB-A-2-329 209, and GB-A-2 339 584. Other patent publications, of which only a few are mentioned here include: EP-A-0 125 993, EP-A-O 143 219, EP-A-O 196 339, EP-A-O 410 729, EP-A-O 506 663, EP-A-O 512 154, EP-A-O 585 315, EP-A-0 671 546, EP-A-O 816 628, EP-A-O 830 492, EP-A-O 920 569, EP-A-O 996 811, EP-A-1 047 859, WO 91/05 093, WO 98/07953, WO 98/37 302, WO 98/37 881, WO 98/40 601, WO 98/50669, WO 99/04132, WO 99/24690, WO 99/25949, WO 99/36660, WO 99/36661, WO 99/48443, WO 00/66874, U.S. Pat. No. 4,077,470, U.S. Pat. No. 4,363,360, U.S. Pat. No. 5,005,642, U.S. Pat. No. 5,095,981, U.S. Pat. No. 5,332,049, U.S. Pat. No. 5,335,723, U.S. Pat. No. 5,797,455, U.S. Pat. No. 5,810,100, U.S. Pat. No. 5,937,948, and U.S. Pat. No. 6,006,830.

It is observed that in practice many of the known centralisers have a preferred orientation for installation in service and are often marked with symbols e.g. arrows to aid the installer. Even so it is often the case that the centralisers are accidentally inverted during installation, and whilst in many cases this has no serious operational consequence, in the case of the more complex designs, incorrect installation can affect the passage of fluids past the centraliser and thus reduce performance.

As in most industries, time and labour represent an inevitable aspect of costs that ultimately affect operational viability and pricing of product to the consumer. Therefore, any improvements that can be made to reduce the time and or labour involved in on-site tasks have an economic impact on production. Improvements in this area can also provide improvements in efficiency and safety. These demands of time and labour against productivity are particularly acute in the-mineral oil and gas industries.

Accordingly, this invention seeks to provide improvements in the installation of tubulars for use in a well bore. Thus an object of the present invention is to obviate or mitigate at least some of the problems that have been observed with the provision of centralisers for tubulars as known in the prior art.

The invention provides according to a first aspect of the invention, a method of providing at least one projection on a tubular body, said projection having a predetermined form such as a blade, ribbing, or the like stand-off projection, by providing materials capable of being moulded, applying a mould to a tubular body, and moulding said materials using said mould onto said tubular body.

An advantage of this method is that it is thereby possible to provide whatever contours of shape or configuration are required for the centraliser by simply designing an appropriate mould cavity for the desired projecting stand-off parts. In this way, it is possible to obtain after the moulding operation upon the tubular the desired combination of raised parts such as blades, ribs, bands and correspondingly between such parts the required forms of fluid pathways in the form of channels, flutes etc. which define recesses with respect to lands formed by the outer surfaces of the projecting parts.

Thus according to another aspect of the invention, there is provided a tubular body, having moulded thereto, in a predetermined position, at least one projection having a predetermined form such as a blade, ribbing, or the like stand-off projection.

Preferably, the method comprises providing composite resin materials loaded with hard particles, and applying the materials directly to an exterior surface portion of a tubular body by means of a mould, and curing the resin materials to provide at least one projection of a predetermined size and shape conforming to the design of the mould pattern.

Preferably, the mould comprises a plurality of cavities adapted to mould materials to a selected shape and size, said cavities being arranged in mould parts capable of being applied around a curved surface to enable a tubular body to have radially projecting parts moulded thereon.

The selective positioning of the mould permits selective location of stand-off parts on the tubular, and it is thereby possible to contemplate infinite variations for design of tubulars having integral centralising or stand-off structures. Blades extending radially with respect to the longitudinal axis of a tubular, for example, may be provided at circumferentially mutually spaced positions uniformly around a tubular such that they are all generally within a discrete cylindrical centralising zone defined around the tubular. Alternatively, the stand-off parts formed by moulding may be in staggered positions, for example, forming upon the tubular off-set or spiral arrangements of centralising or stand-off structures.

Thus the invention enables a prefabricated tubular to be provided for subsequent use in the field, said prefabricated tubular being characterised by integral centraliser formations, said formations being formed as projections moulded directly onto the tubular body.

The tubular body with integral centraliser is preferably formed by providing a resin-ceramic composite material e.g. as powders, particles, fibrils, chopped fibres, beads or the like mouldable particulates, optionally including fillers or other moulding auxiliaries, and means for curing or setting the resin into a moulded form.

The resin material may include bonding agents such as an adhesive or the like curable component, whilst other components to be mixed therewith, whenever moulding is to be carried out may include a hardener, accelerator or curing initiator. The resin-ceramic composite material may also include a catalyst to initiate curing of the resin-ceramic composite. The catalyst may be thermally activated. Alternatively, the mixed materials may be chemically activated by a curing initiator.

The moulding operation may comprise applying an appropriately contoured moulding part to a tubular body, loading the mould with resin-ceramic materials in predetermined amounts to form the desired composite, suitably by injecting the materials into the mould, curing the materials in the mould, and removing the mould parts to leave the desired moulded part formed on the tubular body.

The composite forming materials may be appropriately mixed by use of a pre-calibrated mixing and dosing equipment.

The prefabricated tubular with integral moulded centraliser features obtainable according to the invention may be further treated after removal of the mould parts, e.g. by coating with resins, paints, or bonding of land surface finishing agents thereto.

According to a further aspect of the invention, a composite centraliser for installation on a tubular (OCTG) comprises a tubular core adapted to be installed on a tubular in a manner such as to permit rotation of the tubular within the core in use, said tubular core having moulded thereto, in a predetermined position, at least one projection having a predetermined form such as a blade, ribbing, or the like stand-off projection.

Such a composite centraliser is provided according to a further aspect of the invention, by a method comprising the selection of a tubular core suitable for installation around an OCTG tubular, and providing at least one projection on said tubular core, said projection having a predetermined form such as a blade, ribbing, or the like stand-off projection, by providing materials capable of being moulded, applying a mould to the tubular core, and moulding said materials using said mould onto said tubular core. Such projections provide lands for surface engagement downhole.

The ability of the core to permit the OCTG tubular to rotate down-hole is achievable in an analogous fashion to the so-called “non-rotating” centralisers of the prior art, for example, by providing axial retention means to locate the composite centraliser upon the OCTG tubular, so that whenever the lands of the moulded projection(s) engage a surface within a bore-hole, the composite centraliser thereby becomes static and the OCTG tubular remains free to turn within the composite centraliser, and this may be faciliated by lubrication or roller device modifications according to the prior art. The composite centraliser is installed by axially aligning the tubular with respect to the composite centraliser and inserting the end of the tubular into the core of the composite centraliser and working the centraliser along the outer surface of the tubular until it is located in the desired axial position.

One way of achieving performance of the invention will now be illustrated, by way of example only, with reference to the accompanying drawings in which:

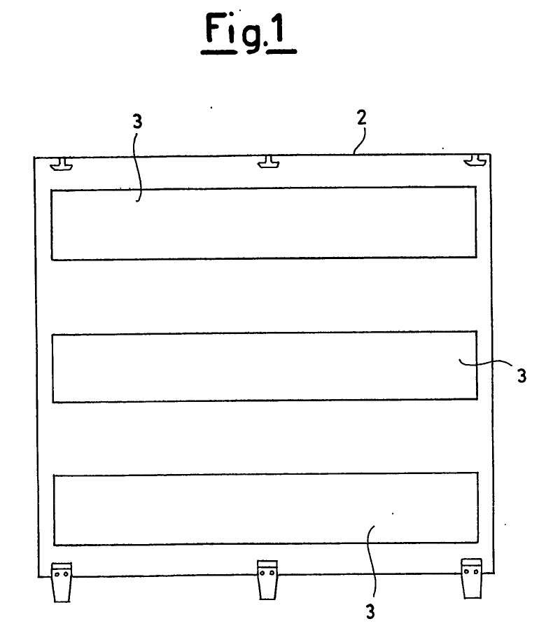

FIG. 1 is a plan view of a mould part;

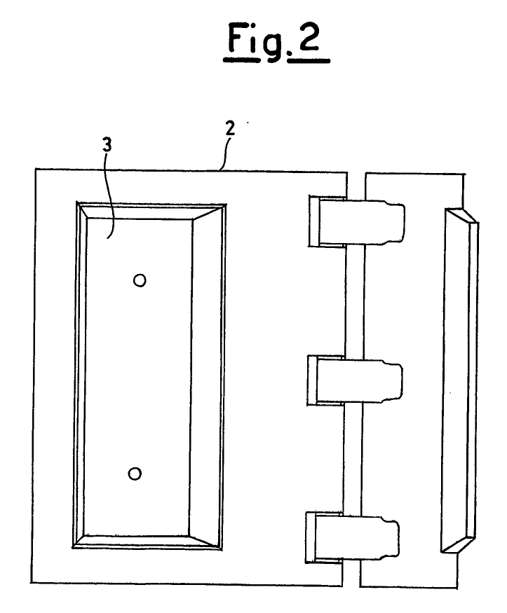

FIG. 2 is a side view of hinged mould parts in an opened position;

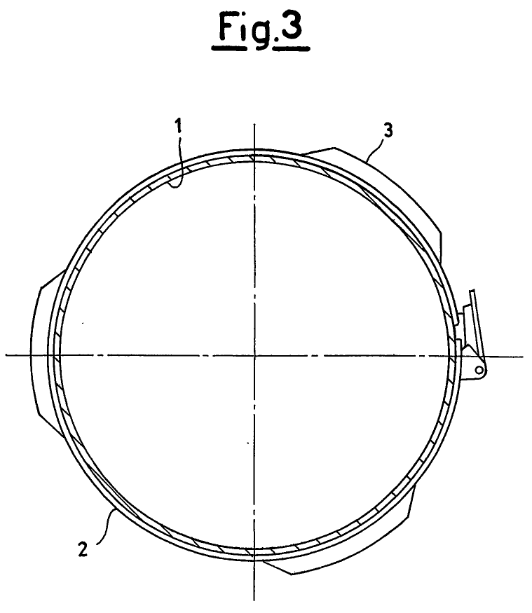

FIG. 3 is a section through a tubular around which the mould parts have been fastened;

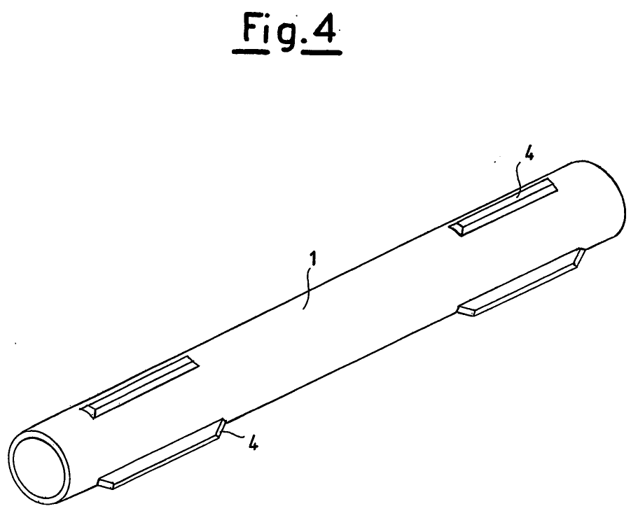

FIG. 4 is an isometric view of a finished prefabricated tubular with integral moulded centraliser features according to one possible embodiment (radial design); and

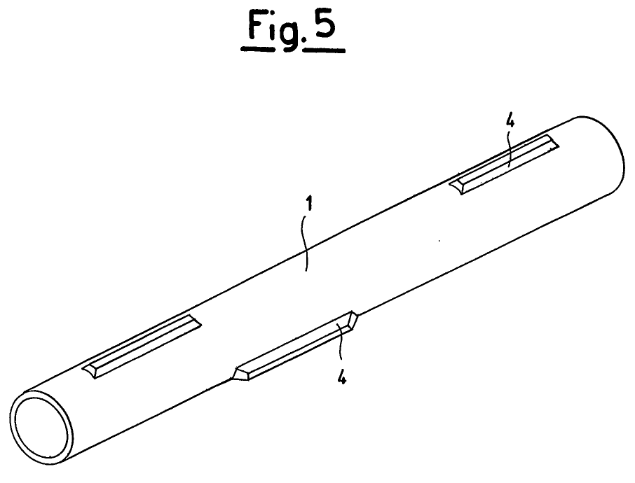

FIG. 5 is an isometric view of a finished prefabricated tubular with integral moulded centraliser features according to another possible embodiment (spiral design).

A prefabricated tubular having appropriate integral centralising capability is formed in the following way. An OCTG tubular, e.g. a pipe 1 is prepared for application of centraliser parts by cleaning to remove possibly interfering contamination such as paint, grease, oil, dust etc. A mould 2 having a plurality of suitable mould cavities 3 for forming projecting parts, e.g. radially extending blades 4, is presented around the tubular at a suitable axial position and fastened directly against the exterior curved surface of the tubular to provide a tight fit sufficient to permit a successful moulding operation. Various patterns of stand-off parts can be formed, e.g. as shown in FIGS. 4 (uniform radial positioning) and 5 (spiral configuration).

A moulding composition, comprising composite resin materials loaded with hard particles is introduced into the mould cavities directly against the tubular wall, and the moulding operation is carried out to cure the moulding composition.

The moulding composition in this case comprises a curable resin, ceramic particulate filler materials, including optional chopped carbon fibre materials. The commercially available PROGUARD CRB can be considered suitable for this purpose.

The composite material here is provided pre-moulding as separate two-part raw material components for admixing for moulding whereby the whole can be reacted. The reaction may be catalytically controlled such that the various components in the separated two parts of the composite material will not react until they are brought together under suitable moulding conditions. Thus the one part may include an activator, or initiator, or catalytic component required to promote, initiate or facilitate the reaction between the whole mixed composition. The appropriate balance of components can be achieved in the mould by use of pre-calibrated mixing and dosing equipment.

The properly mixed and dosed composition cures rapidly in the mould which can then be released from around the tubular, leaving a pre-formed centraliser bonded or fused to the outer surface of the tubular.

In use the pre-fabricated tubular with integral centraliser features is installed and used as for the prior art tubular plus centraliser assemblies, except that the user totally avoids the on-site assembly work. A further advantage is that the user is able to free up storage space normally reserved for the centraliser stock usually taking up deck space separately from the pipe rack.

1-10. (canceled)

11. A prefabricated tubular body for use downhole, comprising:
integral centralizer formations, said formations being formed as projections molded directly onto the tubular body from moldable materials comprising a curable resin, ceramic particulate filler materials, including chopped carbon fiber materials.

12. A prefabricated tubular body according to claim 11, wherein the tubular body is formed by providing a resin-ceramic composite material of one of powders, particles, fibrils, chopped fibers, or beads, including fillers or other molding auxiliaries, and means for curing or setting the resin into a molded form on the tubular body.

13. A prefabricated tubular body according to claim 12, wherein said means for curing or setting the resin comprises a mold, and the mold is utilized in a molded operation that comprises applying at least one appropriately contoured molding part of the mold to a tubular body, loading the mold with resin-ceramic materials in predetermined amounts to form a desired composite, by injecting the materials into the mold, curing the materials in the mold, and removing any mold part to leave a desired molded part formed on the tubular body.

14. A prefabricated tubular body according to claim 11, wherein after removal of the any mold part, the tubular body is coated with resins, paints, or land surface finishing agents.

15. A prefabricated tubular body according to claim 12, wherein after removal of the any mold part, the tubular body is coated with resins, paints, or land surface finishing agents.

16. A prefabricated tubular body according to claim 13, wherein after removal of the any mold part, the tubular body is coated with resins, paints, or land surface finishing agents.

17. A tubular body according to claim 14, wherein the moldable material is PROGUARD CRB.

18. A tubular body according to claim 15, wherein the moldable material is PROGUARD CRB.

19. A tubular body according to claim 16, wherein the moldable material is PROGUARD CRB.

20. A composite centralizer for installation on a tubular (OCTG) body, comprising:
a tubular core configured to be installed on a tubular body to permit rotation of the tubular body within the core in use, the tubular core having molded thereto, in a predetermined position, at least one projection having a predetermined form.

21. A composite centralizer according to claim 20, wherein the at least one projection has a predetermined form of one of a blade, a ribbing, or a stand-off projection.

22. A method of making a composite centralizer comprising:
selecting a tubular core suitable for installation around an OCTG tubular; and
providing at least one projection on the tubular core, the projection having a predetermined form by providing materials capable of being molded, applying a mold to the tubular core, and molding the materials using the mold onto the tubular core.

23. A method according to claim 22, wherein the at least one projection has a predetermined form of one of a blade, a ribbing, or a stand-off projection.

24. A method according to claim 22, wherein the core is made of metal, and the projections, which are molded thereto and provide lands for surface engagement downhole, are formed from a resin-ceramic composite material of one of powders, particles, fibrils, chopped fibers, or beads including fillers or other molding auxiliaries.
